(19) United States
(12) Patent Application Publication
(10) Pub. No.: US 2015/0142260 A1
(43) Pub. Date: May 21, 2015

(54) APPARATUS THAT SUPPORTS STARTING-FAILURE-HANDLING AND METHOD OF HANDLING STARTING FAILURE

(71) Applicant: Hyundai Motor Company, Seoul (KR)

(72) Inventor: Woo Kuen Kim, Seoul (KR)

(21) Appl. No.: 14/302,978

(22) Filed: Jun. 12, 2014

(30) Foreign Application Priority Data
Nov. 20, 2013 (KR) 10-2013-0141622

(51) Int. Cl. G01M 15/02; G01M 15/04; F02M 37/04

(52) U.S. Cl. CPC G01M 15/02; F02M 37/04; G01M 15/042
USPC 701/34.4

(57) ABSTRACT

A method and system of handling starting failure of a vehicle are provided. The method includes detecting, by a controller, a failure occurring in vehicle starting and sensing, by a voltage sensing circuit, the voltage value at at least one point on a fuel pump circuit. In addition, the controller is configured to calculate the current amount based on the sensed voltage value and analyze the cause for the starting failure based on the current amount and the traveling state of a vehicle. Then, the controller is configured to output the handling information for the failure cause.

### CROSS-REFERENCE TO RELATED APPLICATION

This application is based on and claims priority from Korean Patent Application No. 10-2013-0141622, filed on Nov. 20, 2013 in the Korean Intellectual Property Office, the disclosure of which is incorporated herein in its entirety by reference.

### BACKGROUND

1. Field of the Invention

The present invention relates to error handling associated with the starting of a vehicle, and more particularly, to an error handling method and system associated with vehicle starting which may provide information on causes of failure and handling method when the vehicle engine fails to start or stalls.

2. Description of the Prior Art

Vehicles include an engine starting apparatus for traveling and users initially operate the engine starting apparatus to drive vehicles upon entering the vehicle. However, the vehicle engines may fail due to various causes. Further, the started engines of vehicles should be kept operating to drive the vehicle but engines sometimes stall due to various causes while vehicles are traveling.

When a vehicle engine is not normally started or stalls due to various causes while the vehicle is traveling as described above, the engine must be started. Vehicles, however, do not provide drivers with specific information relating to the cause of the starting failure or stall of the engine. Further, these types of failures may occur even due to simple problems such as lack of fuel, etc. However, drivers are not provided with specific information related to the failure cause, and thus causing user inconvenience.

### SUMMARY

Accordingly, the present invention provides a method and apparatus of handling error associated with starting failure which inform a driver of the causes and handling method when an error such as starting failure or stall of the engine of a vehicle occurs.

In one aspect of the present invention, an apparatus that supports starting-failure-handling, may include: a voltage sensing circuit configured to sense a voltage at at least one point on a fuel pump circuit; a controller configured to detect the amount of current at the at least one point based on the sensed voltage and determine a cause of the starting failure based on a state of a vehicle and the voltage and current amount; and an information output unit configured to output information regarding the cause of the starting failure and on how to handle the start failure.

The voltage sensing circuit may be configured to sense the voltage at at least one of a terminal of a fuel pump fuse of the fuel pump circuit and a terminal of a fuel pump motor. The information output unit may be configured to output at least one of information indicating lack of fuel, information regarding a vehicle parked on an uneven surface with insufficient fuel, information regarding melting of the fuel pump fuse, and information regarding breakdown of the fuel pump motor. The information output unit may include at least one of an audio apparatus configured to output the information as an audio signal; a video apparatus configured to output the information as a video signal; and an instrument cluster configured to display the information.

The apparatus may further include a memory configured to store the state information of the vehicle, the cause information, and the handling information for the cause. The controller may be configured to detect the traveling state of the vehicle and detect insufficient fuel by detecting the amount of current flowing to the fuel pump motor when an engine stalls while the vehicle is traveling or when the engine stalls while the vehicle is parked or stationary.

In another aspect of the present invention, a method of handling starting failure, may include: detecting a failure occurring during vehicle starting; sensing a voltage value at at least one point on a fuel pump circuit; calculating the amount of current based on the sensed voltage value; analyzing a cause of the starting failure based on the current amount and a traveling state of a vehicle; and outputting information regarding handling of the failure based on the cause.

The detection of failure occurring in vehicle starting may include at least one of detecting the failure occurring during starting of an engine; and detecting the engine stalling after start-up. The sensing may include at least one of sensing voltage at one terminal of a fuel pump fuse of the fuel pump circuit; and sensing one terminal of a fuel pump motor. The outputting may include one of outputting information indicating lack of fuel; outputting information regarding a vehicle parked on an uneven surface with insufficient fuel; outputting information regarding a melted fuse of the fuel pump; and outputting information regarding breakdown of the fuel pump motor. In addition, the outputting may include outputting the handling information via at least one of an audio apparatus configured to output the information as an audio signal, a video apparatus configured to output the information as a video signal, and an instrument cluster configured to display the information. The method may further include storing in advance a table that includes the state information of the vehicle, the cause information, and the handling information for the causes.

### BRIEF DESCRIPTION OF THE DRAWINGS

The above and other objects, features and advantages of the present invention will be more apparent from the following detailed description taken in conjunction with the accompanying drawings, in which:

FIG. 1 is an exemplary block diagram illustrating an apparatus that supports starting-failure-handling according to an exemplary embodiment of the present invention;

FIG. 2 is an exemplary block diagram illustrating a control module which is one element of a vehicle according to an exemplary embodiment of the present invention; and

FIG. 3 is an exemplary diagram illustrating an error handling method associated with vehicle starting according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware apparatus that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage apparatus. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/of” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, exemplary embodiments of the present invention will be described in detail with reference to the accompanying drawings. In the following description of the exemplary embodiments, matters well known in the art and not directly associated with the present invention will not be described, if possible. This is for communicating the core of the present invention without making it unclear by omitting unnecessary description.

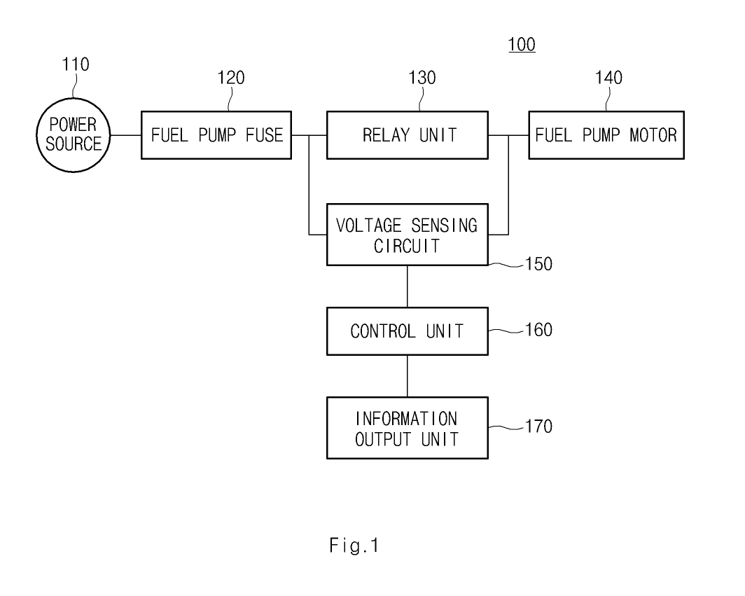

FIG. 1 is an exemplary diagram schematically illustrating the configuration of an apparatus, which supports starting-failure-handling according to an exemplary embodiment of the present invention, for example, a vehicle. Referring to FIG. 1, a starting-failure-handling apparatus 100 may include a power supply 110, a fuel pump fuse 120, a relay unit 130, a fuel pump motor 140, a voltage sensing circuit 150, a controller 160, and an information output unit 170. A vehicle including the starting-failure-handling apparatus 100 may further include other parts such as a fuel tank that supplies fuel to the fuel pump motor 140, an engine supplied with fuel, gears, shafts, and wheels driven by physical force generated by the engine, and another part such as a car body. In the configuration of the starting-failure-handling apparatus 100, necessary configuration for handling starting failures of the present invention is schematically shown in the figure. Accordingly, the configuration of the starting-failure-handling apparatus 100 of the present invention should be construed as not being limited to the configuration described above, but further including various parts of a vehicle such as headlights, an acceleration apparatus, and a steering apparatus.

The starting-failure-handling apparatus 100 may be configured to measure the voltage of the fuel pump-related circuit and calculate the amount of current based on the measured voltage, when an error such as starting failure or stall of an engine occurs. Further, the starting-failure-handling apparatus 100 may be configured to estimate the cause of the starting failure and may determine a handling method for the failure based on the information regarding the calculated amount of current and the previous state. When a handling method is determined, the starting-failure-handling apparatus 100 may be configured to provide appropriate measures (e.g., methods for repairing the failure) for the failure to a driver by outputting cause information and handling information.

The power supply 110 may be configured to support a vehicle by generating power for driving the vehicle. The power supply 110 may be a battery and may be disposed at a predetermined space within the starting-failure-handling apparatus 100, for example, near an engine. The power supply 110 may be configured to supply power for driving the fuel pump motor 140 through the fuel pump fuse 120 and the relay unit 130.

The fuel pump fuse 120 may be configured to prevent overcurrent from the power supply 110, between the power supply 110 and the relay unit 130. For example, the fuel pump fuse 120 may be configured to protect the fuel pump circuit such as the relay unit 130 by cutting, when a predetermined amount of overcurrent flows in the vehicle due to water, or humidity, or other various environments while the power of the power supply 110 is transmitted to the relay unit 130. The relay unit 130 may be configured to adjust supply or interruption of power to the fuel pump motor 140. The operation of the relay unit 130 may be to supply fuel to the cylinders within an engine. The relay unit 130 may include a coil assembly configured to generate an electric field in response to a control signal from the controller 160 and a relay switch turned on/off by the electric field of the coil assembly. The relay unit 130 may be disposed between the fuel pump fuse 120 and the fuel pump motor 140.

The fuel pump motor 140 may be configured to produce power for a fuel pump to pump up fuel to an engine. The fuel pump motor 140 may be connected to the relay unit 130. In addition, the fuel pump motor 140 may be connected to the relay unit 130 and operated by on-off control of the relay unit 130. The amount of current flowing to the fuel pump motor 140 may depend on the amount of fuel in the fuel tank. In other words, the amount of current flowing to the fuel pump motor 140 may depend on various states of the fuel tank, for example, when the fuel tank is fully filled with fuel, half filled with fuel, filled with a little fuel, and empty (e.g., various fuel levels of the fuel tank).

The voltage sensing circuit 150 may be configured to sense a change in voltage at a predetermined point on the fuel pump circuit. For example, the voltage sensing circuit 150 may be configured to sense a change in voltage between the fuel pump fuse 120 and the relay unit 130. Further, the voltage sensing circuit 150 may be configured to sense a change in voltage between the relay unit 130 and the fuel pump motor 140. The values of voltage sensed and collected by the voltage sensing circuit 150 may be transmitted to the controller 160. The voltage sensing circuit 150 may be configured to transmit the information regarding the positions where the voltage is sensed, with the values of the sensed voltage, to the controller 160.

The information output unit 170 may be configured to output the information from the controller 160. That is, the controller 160 may be configured to operate the information output unit 170. For example, the information controller 170 may include an AVN (Audio/Video/Navigation) or an instrument cluster. The AVN apparatus may include an audio output module that may be configured to output cause information and handling information for starting failure with audio signals and a video output module that may be configured to output cause information and handling information using text or images. The starting-failure-handling apparatus 100 may include a memory executed by the controller 160 to store the cause information and the handling information. The memory may include tables in which vehicle state information, cause information, and handling information are arranged.

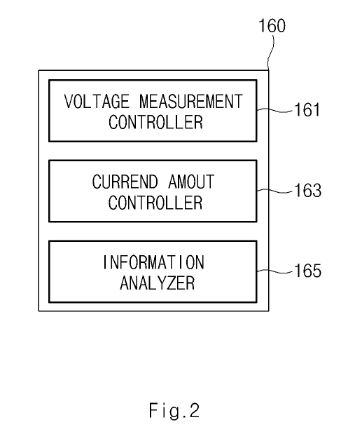

The controller 160 may be configured to process various signals for operating the starting-failure-handling apparatus 100 and transmit, analyze, and output data. The controller 160 may be an MCU (Motor Control Unit) for a vehicle. In particular, the controller 160 may include the configuration shown in FIG. 2 to support the function of handling a starting failure of the present invention.

FIG. 2 is an exemplary diagram illustrating the configuration of the controller in the apparatus that performs starting-failure-handling according to an exemplary embodiment of the present invention. Referring to FIG. 2, the controller 160 of the present invention may include a voltage measurement controller 161, a current amount calculator 163, and an information analyzer 165.

The voltage measurement controller 161 may be configured to collect voltage sensor information on at least one of the predetermined points, for example, behind the fuel pump fuse 120 and ahead of the fuel pump motor 140 by operating the voltage sensing circuit 150. Further, the voltage measurement controller 161 may be configured to transmit the collected voltage sensor information to the current amount calculator 163. The voltage measurement controller 161 may be configured to operate the voltage sensing circuit 150, when a starting failure occurs. For example, the voltage measurement controller 161 may be configured to operate the voltage sensing circuit 150, when an input signal is generated by the starting of the engine, for example, when a driver pushes a start button or inserts the key and turns it in a predetermined direction.

Alternatively, the voltage measurement controller 161 may be configured to operate the voltage sensing of the voltage sensing circuit 150, when the engine fails to start after an input for starting the engine is provided. Further, the voltage measurement controller 161 may be configured to operate the voltage sensing by activating the voltage sensing circuit 150 when the engine stalls while the vehicle is traveling without an instruction to stall the engine. Furthermore, the starting-failure-handling apparatus 100 may provide an input apparatus such as a button or a touch key for performing the function of handling a starting failure of the present invention. In response to a request for perform the function of handling a starting failure by selection via the input apparatus, the voltage measurement controller 161 may be configured to transmit voltage sensing and sensor information.

When the voltage sensing circuit 150 measures voltage by operation of the voltage measurement controller 161, the current amount calculator 163 may be configured to calculate the current amount from the measured voltage. For example, the current amount calculator 163 may be configured to calculate the amount of current flowing behind the fuel pump fuse 120. Further, the current amount calculator 163 may be configured to calculate the amount of current flowing behind the relay unit 130 or in front of the fuel pump motor 140. The current amount calculator 163 may be configured to calculate the current amount from a change in voltage by monitoring the value of the voltage at a predetermined point on the fuel pump circuit before the engine starts or when the engine starts and by receiving the value of the voltage at a predetermined point of time. The current amount calculator 163 may be configured to transmit the information regarding the calculated current amount to the information analyzer 165.

The information analyzer 165 may be configured to estimate the cause for a starting failure of the vehicle based on the information regarding the traveling state of the vehicle and the information regarding the current amount transmitted from the current amount calculator 163 and select handling information for the cause of the failure. Accordingly, the information analyzer 165 may be configured to collect information regarding whether an input to start the engine of a vehicle which is not started was received. Further, the information analyzer 165 may be configured to collect information regarding whether the engine of the vehicle is operating. Further, the information analyzer 165 may refer to (e.g., may be configured to access) the table having vehicle state information, causes, and handling information for the causes, from the memory. The information analyzer 165 may be configured to transmit the referred values to the information output unit 170 and transmit the information in a method such as control area network (CAN), local interconnect network (LIN), or personal identification number (PIN) to PIN.

The information in the table may include the vehicle state information, cause information, and handling information, as described above. The vehicle state information may include the state when the engine stalls due to fuel shortage while traveling, the state when the vehicle parked on an uneven surface has insufficient fuel, the state when the fuel pump motor is disabled, and the state of the fuel pump fuse melted. The cause information when the engine stalls due to fuel shortage while traveling may mean that the amount of current flowing to the fuel pump motor 140 is less than a predetermined amount from a desired value, when the vehicle travels in an ignition (IGN)-On state and a vehicle speed exists (e.g., is above 0), before the engine stalls. The cause information when the vehicle is parked on an uneven surface with insufficient fuel may mean that the amount of current flowing to the fuel pump motor 140 is less than a predetermined amount from a desired value, when the vehicle travels in an IGN-Off state and the vehicle speed is about 0, before the engine stalls. The cause information when the fuel pump motor is disabled may mean that the current amount of the fuel pump motor 140 is about 0 A with a predetermined amount of supply voltage at the terminal of the fuel pump fuse, for example, about 10 V or more. Further, the cause information when the fuel pump fuse is melted may mean that the current amount of the fuel pump motor 140 is about 0 A with supply voltage of about 0 V at the terminal of the fuel pump fuse 120.

Furthermore, the table may include information that provides instructions to supply fuel as the handling information for fuel shortage while traveling, and to supply fuel or balance the inclined vehicle as the handling information when the vehicle parked on an uneven surface with insufficient fuel. Further, the table may include information that provides instructions to repair the vehicle as the handling information for the breakdown of the fuel pump motor 140, and to replace a fuse as the handling information for the melted fuse of the fuel pump fuse 120. The information output unit 170 may be configured to receive the information in the table from the information analyzer 165 and output the information through at least one of an audio apparatus or a video apparatus in accordance with user settings.

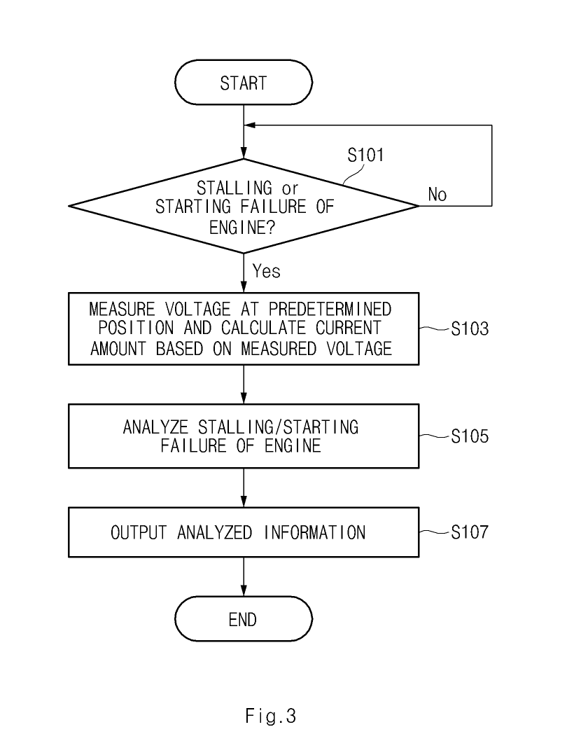

FIG. 3 is an exemplary diagram illustrating an error handling method associated with vehicle starting according to an exemplary embodiment of the present invention. Referring to FIG. 3, according to the error handling method associated with vehicle starting of the present invention, the controller 160 may be configured to determine whether an engine stalls or fails to start in operation S101. For example, the controller 160 may be configured to determine whether an engine fails to start when a starting signal is input. In other words, the controller 160 may be configured to determine that the engine failed to start, when the engine is not started within a predetermined time after the starting signal is input. Further, the controller 160 may be configured to determine whether the engine stalls without an input from a user, for example, without an input for stalling the engine in operation.

Moreover, the starting-failure-handling apparatus 100 may be configured to store in advance a table that includes the vehicle state information, cause information, and handling information for the causes in the memory. When a starting error such as stalling or starting failure of an engine occurs, the controller 160 may be configured to execute voltage measurement at a predetermined position and calculate the current amount from the measured voltage in operation S103. For example, the controller 160 may be configured to measure the voltage values at the points behind the fuel pump fuse 120 and ahead of the fuel pump motor 140. Further, the controller 160 may be configured to calculate the current amount at corresponding points based on the result of previous monitoring and the currently collected voltage values.

In operation S105, the controller 160 may be configured to analyze the stalling/starting failure of the engine based on the information regarding the measured voltage and current amount and other various driving states of the vehicle. For example, the controller 160 may be configured to determine whether the vehicle is traveling, the fuel filling state, the amount of current flowing to the fuel pump motor 140, and the fuel pump fuse 120.

The controller 160 may be configured to output the analyzed information in operation S107. In this process, the controller 160 may be configured to determine the obtained state and cause of the vehicle and determine corresponding handling information. Further, the controller 160 may be configured to transmit the vehicle state, cause information, and handling information to the information output unit 170. The information output unit 170 may be configured to output the information from the controller 160 via at least one of an audio apparatus and a video apparatus. Further, the information output unit 170 may be configured to output the information to an instrument cluster as types of predetermined images or texts.

As described above, the apparatus 100 that supports the function of handling a starting failure according to an exemplary embodiment of the present invention may be configured to support a user to more correctly recognize the causes and provide measures, by outputting the cause and handling information, when starting failure of a vehicle occurs. As set forth above, according to the method of handling a starting failure of a vehicle and an apparatus supporting the method, it may be possible to enable a user to more appropriately and correctly handle the failure of a vehicle by informing the user of the cause of the failure and providing handling instructions. Therefore, according to an exemplary embodiment of the present invention, unnecessary costs may be prevented, waste of time may be avoided, and emergency measure for the failure may be performed.

Exemplary embodiments have been described in the detailed description and the accompanying drawings. Herein, although specific terms have been used, these are merely used for the purpose of easily describing the present invention but not used for limiting the scope of the present invention. It is obvious to those skilled in the art that various modifications may be made without departing from the scope of the present invention, other than the exemplary embodiments described herein.

What is claimed is:

1. An apparatus that supports starting-failure-handling, comprising:
a voltage sensing circuit configured to sense a voltage at at least one point on a fuel pump circuit;
a controller configured to:
determine the amount of current at the at least one point based on the sensed voltage;
determine a cause of the starting failure based on a state of a vehicle and the voltage and current amount; and
output information regarding the cause of the starting failure and handling instructions regarding the start failure.

2. The apparatus according to claim 1, wherein the voltage sensing circuit is configured to sense the voltage at at least one of a terminal of a fuel pump fuse of the fuel pump circuit and a terminal of a fuel pump motor.

3. The apparatus according to claim 2, wherein the controller is configured to output at least one of information indicating lack of fuel, information regarding a vehicle parked on an uneven surface with insufficient fuel, information regarding a melted fuse of the fuel pump, and information regarding failure of the fuel pump motor.

4. The apparatus according to claim 3, wherein the controller is configured to output information via at least one selected from a group consisting of: an audio apparatus that outputs the information as an audio signal; a video apparatus that outputs the information as a video signal; and an instrument cluster that displays the information on a display.

5. The apparatus according to claim 1, wherein the controller is configured to store the state information of the vehicle, the cause information, and the handling information for the cause on a memory.

6. The apparatus according to claim 1, wherein the controller is configured to determine the traveling state of the vehicle and determine when fuel is insufficient by determining the amount of current flowing to the fuel pump motor when an engine stalls while the vehicle is traveling or when the engine stalls while the vehicle is parked or stationary.

7. A method of handling starting failure, comprising:
detecting, by a controller, a failure occurring in vehicle starting;
sensing, by a voltage sensing circuit, a voltage value at at least one point on a fuel pump circuit;
calculating, by the controller, the amount of current based on the sensed voltage value;
analyzing, by the controller, a cause of the starting failure based on the current amount and a traveling state of a vehicle; and
outputting, by the controller, information regarding handling instructions for the failure cause.

8. The method according to claim 7, wherein detecting the failure occurring in vehicle starting includes at least one of: the failure occurring in starting an engine; and the engine stalling after start-up.

9. The method according to claim 7, wherein the sensing includes at least one of: sensing voltage at one terminal of a fuel pump fuse of the fuel pump circuit; and sensing one terminal of a fuel pump motor.

10. The method according to claim 7, wherein the outputting includes one of: outputting information indicating lack of fuel; outputting information regarding a vehicle parked on an uneven surface with insufficient surface; outputting information regarding a melted fuse of the fuel pump; and outputting information regarding failure of the fuel pump motor.

11. The method according to claim 7, wherein the outputting includes outputting the handling information via at least one of an audio apparatus configured to output the handling information as an audio signal, a video apparatus configured to output the handling information as a video signal, and an instrument cluster configured to display the information on a display.

12. The method according to claim 7, further comprising:
storing, by the controller, in advance a table that includes the state information of the vehicle, the cause information, and the handling information for the causes.

13. A non-transitory computer readable medium containing program instructions executed by a controller, the computer readable medium comprising:
program instructions that detect a failure occurring in vehicle starting;
program instructions that control a voltage sensing circuit to sense a voltage value at at least one point on a fuel pump circuit;
program instructions that calculate the amount of current based on the sensed voltage value;
program instructions that analyze a cause of the starting failure based on the current amount and a traveling state of a vehicle; and
program instructions that output information regarding handling instructions for the failure cause.

14. The non-transitory computer readable medium of claim 13, wherein detecting the failure occurring in vehicle starting includes at least one of: the failure occurring in starting an engine; and the engine stalling after start-up.

15. The non-transitory computer readable medium of claim 13, wherein the sensing includes at least one of: sensing voltage at one terminal of a fuel pump fuse of the fuel pump circuit; and sensing one terminal of a fuel pump motor.

16. The non-transitory computer readable medium of claim 13, wherein the outputting includes one of: outputting information indicating lack of fuel; outputting information regarding a vehicle parked on an uneven surface with insufficient surface; outputting information regarding a melted fuse of the fuel pump; and outputting information regarding failure of the fuel pump motor.

17. The non-transitory computer readable medium of claim 13, wherein the outputting includes outputting the handling information via at least one of an audio apparatus configured to output the handling information as an audio signal, a video apparatus configured to output the handling information as a video signal, and an instrument cluster configured to display the information on a display.

18. The non-transitory computer readable medium of claim 13, further comprising:
program instructions that store in advance a table that includes the state information of the vehicle, the cause information, and the handling information for the causes.
